(19) United States
(12) Patent Application Publication
(10) Pub. No.: US 2007/0028146 A1
(43) Pub. Date: Feb. 1, 2007

(54) Semiconductor memory device system, and method for operating a semiconductor memory device system

(76) Inventor: Hermann Ruckerbauer, Moos (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/495,230

(22) Filed: Jul. 28, 2006

(30) Foreign Application Priority Data
Jul. 29, 2005 (DE) 10 2005 035 661.3

(51) Int. Cl. G06F 11/00; H04L 1/00

(52) U.S. Cl. 714/42; 714/746; 711/100

(57) ABSTRACT

A method for operating a semiconductor memory device system, and a semiconductor memory device system are disclosed. In one embodiment, the system includes a memory device and a control means connected with the memory device via a bus system, wherein a single signal line or a single signal line pair of the bus system is provided for the transmission of a status signal that signalizes that control data are to be transmitted from the memory device to the control means, or from the control means to the memory device.

### CROSS-REFERENCE TO RELATED APPLICATIONS

This Utility Patent Application claims priority to German Patent Application No. DE 10 2005 035 661.3 filed on Jul. 29, 2005, which is incorporated herein by reference.

### BACKGROUND

The invention provides for a semiconductor memory device system and a method for operating a semiconductor memory device system.

In the case of semiconductor memory devices one differentiates between functional memory devices (e.g., PLAs, PALs, etc.), and table memory devices, e.g., ROM devices (ROM=Read Only Memory), and RAM devices (RAM=Random Access Memory or read write memory).

A RAM device is a memory for storing data under a predetermined address and for reading out the data under this address again later.

Since as many memory cells as possible are to be accommodated in a RAM device, one has been trying to realize them as simple as possible. In the case of SRAMs (SRAM=Static Random Access Memory), the individual memory cells consist e.g., of few, for instance 6, transistors, and in the case of DRAMs (DRAM=Dynamic Random Access Memory) in general only of one single, correspondingly controlled transistor or capacitor with the capacitance of which one bit each can be stored as charge. This charge, however, remains for a short time only. Therefore, a “refresh” must be performed regularly, e.g., approximately every 64 ms.

For technological reasons, the individual memory cells are, in the case of memory devices, in particular DRAM devices, arranged side by side in a plurality of rows and columns in a rectangular matrix (that is regularly subdivided into a plurality of cell fields) or a rectangular array (that is regularly subdivided into a plurality of cell fields), respectively.

In order to achieve a correspondingly high overall storage capacity and/or a data read or write rate that is as high as possible, instead of one single array, a plurality of, e.g., four—rectangular—individual arrays may be provided in an individual RAM device or chip (“multi-bank chip”) (“memory banks”).

In a semiconductor memory device system, a corresponding semiconductor memory device, e.g., a DRAM device, may be connected to one or a plurality of micro processors or micro controllers, respectively, via an appropriate control means, e.g., a memory controller.

The control means or the memory controller is connected with the semiconductor memory device, e.g., the DRAM device, via a bus system including a data bus, an address bus, and a control bus.

After, by means the above-mentioned control means or memory controller, via the above-mentioned address bus, a corresponding address, and via a write/read command signal line of the above-mentioned control bus, a corresponding write command, have been input into the DRAM device, corresponding data—that are present at the above-mentioned data bus—can be stored in the DRAM device under the respective address.

The data stored under this address can later again be read out from the DRAM device and be output at the above-mentioned data bus (in that, by means of the above-mentioned control means or the memory controller, via the above-mentioned address bus, the corresponding address is input into the DRAM device and, via the above-mentioned write/read signal line of the above-mentioned control bus, a corresponding read command is input).

The above-mentioned control bus may include a series of further signal lines, e.g., a reset signal line (“reset” line), an overheating status signal line (“Temp_overheat” line), a checksum error status signal line (“ECC_err” line), etc. (or—in the case of differential signal lines—corresponding signal line pairs).

If, for instance, the respective DRAM device sends, on exceeding a particular limit temperature, a corresponding overheating status signal to the control means or the memory controller via the overheating status signal line, the control means or the memory controller may correspondingly delay the further reading or writing of data from the DRAM device or into the DRAM device, respectively, so that the DRAM device may cool down again.

Furthermore—if the control means or the memory controller sends a reset signal to the DRAM device via the reset signal line (“RESET” line)—the DRAM device may be reset to a predefined initial state, etc.

The above-mentioned further signal lines (“RESET” line, “Temp_overheat” line, “ECC_err” line, etc.) result—especially if differential signal lines are used—in a relatively high number of pins to be provided at the respective DRAM device.

For these and other reasons, there is a need for the present invention.

### SUMMARY

In one embodiment, the invention provides a method for operating a semiconductor memory device system, and a semiconductor memory device system having a memory device and a control means that is connected with the memory device via a bus system, wherein a single signal line or a single signal line pair of the bus system is provided for the transmission of a status signal that signalizes that control data are to be transmitted from the memory device to the control means, or from the control means to the memory device.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a schematic exemplary representation of the structure of a semiconductor memory device system including a semiconductor memory device and a memory device control means in accordance with an embodiment of the present invention.

FIG. 2 illustrates a schematic exemplary representation of method steps performed with a method for operating a semiconductor memory device system according to the embodiment of the present invention.

FIG. 3 illustrates a schematic exemplary representation of the structure of a semiconductor memory device system including a semiconductor memory device and a memory device controller according to a further, alternative embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims. The present invention provides a novel semiconductor memory device system and a novel method for operating a semiconductor memory device system, in particular a system and a device in which—as compared to prior art—the number of pins to be provided at the respective memory device can be reduced.

In accordance with one embodiment of the invention there is provided a semiconductor memory device system having a memory device and a control means connected with the memory device via a bus system, wherein a single signal line or a single signal line pair of the bus system is provided for transmitting a status signal (RESET/TEMP_OVERHEAT/ECC_ERR/POWERDOWNEXIT) that signalizes that control data are to be transmitted from the memory device to the control means, or from the control means to the memory device.

The bus system includes a reference data bus, an address bus, and a control bus, and the signal line or the signal line pair is part of the control bus, wherein the control data are transmitted via the reference data bus—which is otherwise provided for the transmission of reference data—, and/or via the address bus—which is otherwise provided for the transmission of address data.

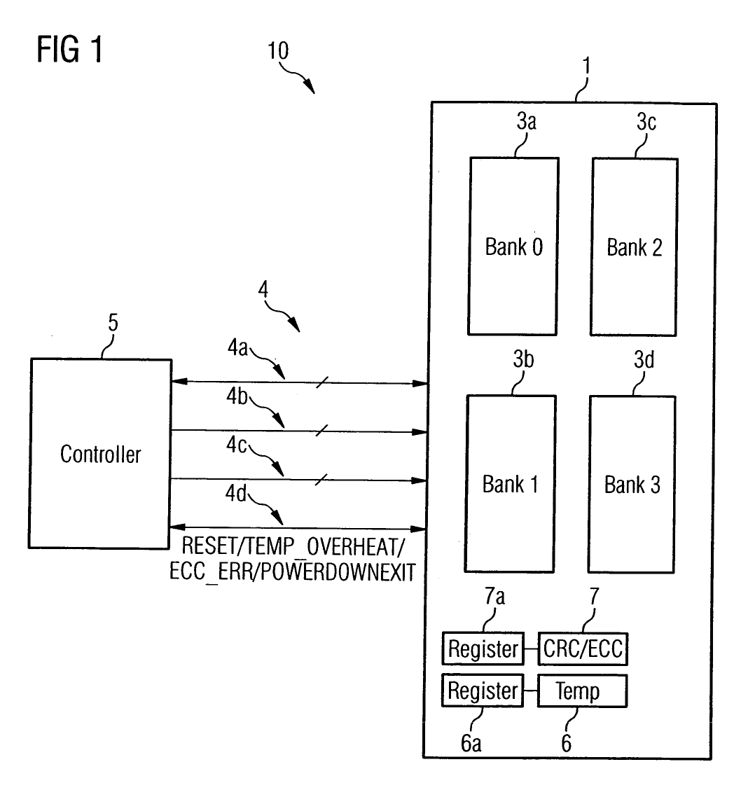

FIG. 1 illustrates a schematic representation of the structure of a semiconductor memory device system 10 with a semiconductor memory device 1 or a semiconductor memory chip, respectively, and a—central—memory device control means 5 or memory controller, respectively.

The semiconductor memory device 1 and the memory device control means 5 may be provided on two different chips, or may alternatively be integrated jointly on one single chip.

The control means 5 or the memory controller, respectively, is connected with the semiconductor memory device 1 via a bus system 4. The bus system 4—a high-speed bus system—comprises a (reference) data (“data”) bus 4a, an address (“address”) bus 4b, and a control (“control”) bus 4c.

The signals transmitted via the bus system 4 (i.e. the data bus 4a and/or the address bus 4b and/or the control bus 4c) may, for instance, each be “single ended” signals (i.e. signals that are each transmitted via corresponding single lines of the bus system 4), or—alternatively—each “differential” signals (i.e. signals that are each transmitted via corresponding line pairs of the bus system 4 which are assigned to each other).

Each line of the bus system 4 may be connected with a corresponding pin of the semiconductor memory device 1, and with a corresponding pin of the control means 5.

As semiconductor memory device 1, e.g., a table memory device based, for instance, on CMOS technology, e.g., a RAM memory device (RAM=Random Access Memory or read write memory), in particular a SRAM memory device (SRAM=Static Random Access Memory), or a DRAM memory device (DRAM=Dynamic Random Access Memory) may be used.

After, by means of the control means 5 or the memory controller, via the above-mentioned address bus 4b, a corresponding address, and via a write/read command signal line of the above-mentioned control bus 4c, a corresponding write command, have been input into the semiconductor memory device 1, corresponding data—that are present at the above-mentioned data bus 4a—can be stored in the semiconductor memory device 1 under the respective address.

The address may be input in several, e.g., two successive steps (e.g., first a row address (“row address”)—and possibly parts of a column address (“column address”)—, and then the column address (“column address”) (or the remaining parts of the column address, respectively (“column address”))).

The data input into the semiconductor memory device 1 are stored in corresponding memory cells there and may be read out of the corresponding memory cells again later.

Each memory cell consists e.g., of few elements, in particular only of one single, correspondingly controlled transistor or capacitor with the capacitance of which one bit each can be stored as charge.

As results from FIG. 1, a particular number of memory cells each is positioned—side by side in a plurality of rows and columns—in a rectangular or square array (“memory bank”) 3a, 3b, 3c, 3d, so that—corresponding to the number of memory cells contained—e.g., 32 MBit, 64 MBit, 128 MBit, 256 MBit, etc. each can be stored in an array 3a, 3b, 3c, 3d.

As is further illustrated in FIG. 1, the semiconductor memory device 1 comprises a plurality of, e.g., four, memory cell arrays 3a, 3b, 3c, 3d (here: the memory banks 0-3) that are each of identical structure, are distributed evenly over the area of the device, and are controlled by the above-mentioned memory device control means 5 independently of each other, so that correspondingly a total storage capacity of e.g., 128 MBit, 256 MBit, 512 MBit, or 1024 MBit (or 1 GBit) results for the semiconductor memory device 1.

By the providing of a plurality of independent arrays 3a, 3b, 3c, 3d it can be achieved that—in parallel or overlapping in time—corresponding write or read accesses may be performed in several, different arrays 3a, 3b, 3c, 3d.

The data stored in the semiconductor memory device 1 under a particular address in the above-described manner may later be read out again from the semiconductor memory device 1 under the respective address and be output at the above-mentioned data bus 4a.

To this end, a corresponding read command is input into the semiconductor memory device 1 by the control means 5 or the memory controller via the above-mentioned write/read command signal line of the above-mentioned control bus 4c, and via the above-mentioned address bus 4b the corresponding address (possibly in several, e.g., two successive steps (e.g., first the row address (“row address”)—and possibly parts of the column address (“column address”)—, and then the column address (“column address”) (or the remaining parts of the column address, respectively (“column address”)))).

As results from FIG. 1, the bus system 4 comprises, as part of the control bus 4c, in addition to the above-mentioned conventional CArDwD signal lines (CArDwD lines=Command-Address-Read-Write lines, i.e. the lines provided for the regular operation of the semiconductor memory device 1)—if single-ended signals and corresponding signal single lines are used—a further, specific signal single line 4d that will be explained in more detail in the following, or—alternatively, if differential signals and corresponding signal line pairs are used—a further, specific signal line pair 4d that will be explained in more detail in the following.

Via the further line 4d or the further signal line pair 4d, respectively, a specific, combined status signal (signal RESET/TEMP_OVERHEAT/ECC_ERR/POWERDOWNEXIT) is transmitted, as will be explained in more detail in the following.

The further line 4d or the further line pair 4d, respectively, is operated bidirectionally and replaces the plurality of specific unidirectional status lines (e.g., a reset signal line (“reset” line), an overheating status signal line (“Temp_overheat” line), a checksum error status signal line (“ECC_err” line), and an awake signal line (“PowerDownExit”), or the corresponding line pairs, respectively) provided with semiconductor memory device systems known in prior art in addition to the above-mentioned CArDwD signal lines.

As results from FIG. 1, the semiconductor memory device 1 comprises a temperature measuring means 6, and an error detection or correction control means 7.

The temperature measuring means 6 measures, in predetermined, e.g., regular time intervals, the temperature T that currently prevails on the semiconductor device 1.

The temperature measuring means 6 compares the measured, currently prevailing temperature T with a predetermined temperature threshold value T_{comp} that is stored in a register (which is not illustrated).

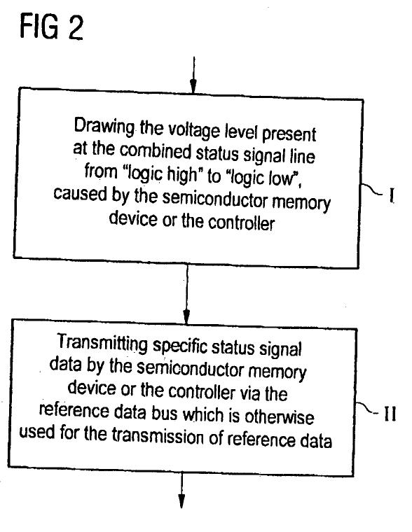

If the measured temperature T is higher than the threshold value T_{comp}, the temperature measuring means 6 initiates that the voltage level at the above-mentioned further line 4d is drawn from “logic high” to “logic low” (cf. also step I illustrated in FIG. 2)—or at a first line of the further line pair 4d from “logic high” to “logic low”, respectively, and at a second line of the further line pair 4d from “logic low” to “logic high”. In other words, the temperature measuring means 6 sends, via the further line 4d or the further line pair 4d, respectively, the above-mentioned status signal RESET/TEMP_OVERHEAT/ECC_ERR/POWERDOWNEXIT to the memory device control means 5. Shortly afterwards, the further line 4d is again drawn back from “logic low” to “logic high” by the temperature measuring means 6 (or the first line of the further line pair 4d is drawn back from “logic low” to “logic high”, and the second line of the further line pair 4d back from “logic high” to “logic low”, respectively). Alternatively, the temperature measuring means 6 may first wait for the receipt of a signal sent by the control means 5 and acknowledging the receipt of the status signal RESET/TEMP_OVERHEAT/ECC_ERR/POWERDOWNEXIT.

The data representing the current temperature T measured by the temperature measuring means 6, and/or a bit that indicates that the above-mentioned threshold value T_{comp} has been exceeded are written into a register 6a provided on the semiconductor memory device 1.

After the sending of the status signal RESET/TEMP_OVERHEAT/ECC_ERR/POWERDOWNEXIT, the data stored in the register 6a, and the data stored in an additional register 7a that is provided on the semiconductor memory device 1 and will be explained in more detail in the following, are (e.g., simultaneously, or successively) read out, and (e.g., simultaneously, or successively) transmitted, via the above-mentioned reference data bus 4a of the bus system 4—which is otherwise provided for the transmission of reference data—, from the semiconductor memory device 1 to the memory device control means 5 or the memory controller 5 (cf. also step II illustrated in FIG. 2). Alternatively, only the data stored in the register 6a are read out and transmitted to the memory device control means 5 or the memory controller 5.

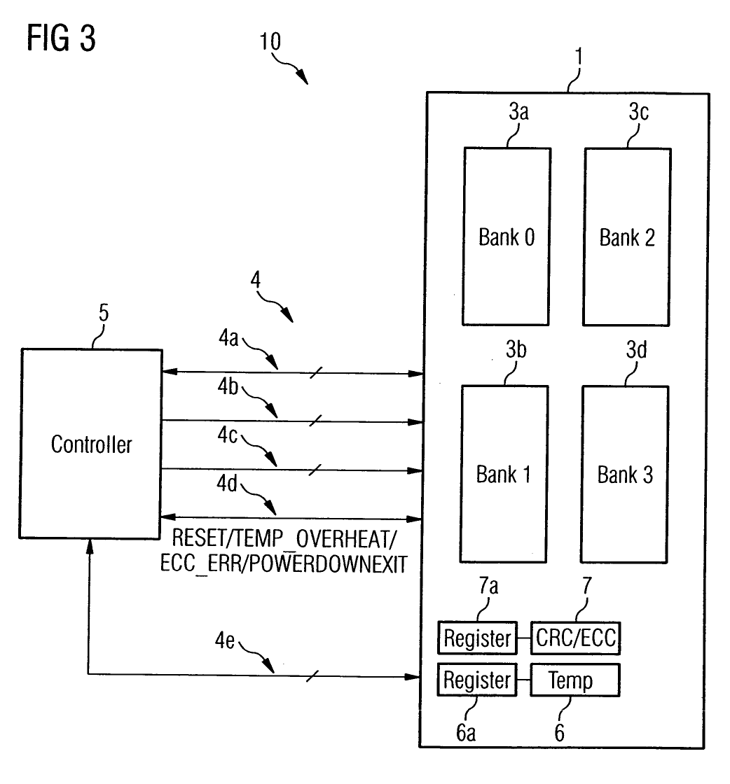

In an embodiment of the invention that is illustrated in FIG. 3, the data stored in the register 6a and the data stored in the additional register 7a can, instead via the reference data bus 4a of the bus system 4, also be transmitted from the semiconductor memory device 1 to the memory device control means 5 or the memory controller 5 via a separate, additional bus system 4e (again e.g., simultaneously (or successively)).

The signals transmitted via the additional bus system 4e may, for instance, each be “single-ended” signals (i.e. signals that are each transmitted via corresponding single lines of the additional bus system 4e), or—alternatively—each “differential” signals (i.e. signals that are each transmitted via corresponding line pairs of the additional bus system 4e which are assigned to each other).

As additional bus system 4e, a low speed bus may, for instance, be used, i.e. a bus system via which the corresponding data are transmitted at a lower data rate than via the above-mentioned (high-speed) bus system 4.

In a further embodiment, the transmission of the data stored in the registers 6a, 7a may also be performed from the semiconductor memory device 1 to the memory device control means 5 or the memory controller 5—instead via an additional bus system 4e, or the reference data bus 4a of the bus system 4—via the above-mentioned further line 4d or the above-mentioned further line pair 4d, respectively.

By means of the error detection or correction control means 7 that has already been mentioned briefly above it is determined—in a per se known manner—whether errors have occurred during the storing of (reference) data in the memory cell arrays 3a, 3b, 3c, 3d of the semiconductor memory device 1, and/or during the reading out of (reference) data from the memory cell arrays 3a, 3b, 3c, 3d of the semiconductor memory device 1.

To this end, corresponding error-detecting or error-correcting codes may be used.

The simplest method of error detection consists in the—additional—transmission and storage of a parity bit as a check bit.

In the case of a “even” parity, the additionally transmitted parity bit is, for instance, set to Zero if the number of Ones in the remaining data bits to be transmitted is even, and to One, if the number of Ones in the remaining bits to be transmitted is odd.

Vice versa—in the case of a co-called “odd” parity—the additionally transmitted parity bit is set to One if the number of Ones in the remaining data bits to be transmitted is even, and to Zero if the number of Ones in the remaining data bits to be transmitted is odd.

For error detection, the—additionally transmitted—parity bit is stored together with the transmitted data bits that are to be stored.

During the reading out of the data bits, the corresponding parity bit is—anew—calculated and compared with the stored parity bit. If a difference results, an error has occurred.

If a plurality of bits are disturbed, an odd error number can be detected by means of the above-mentioned parity bit method, an even number, however, cannot be detected.

By the transmission of a plurality of check bits (instead of one single parity bit) the above-mentioned principle can be improved such that an error cannot only be detected, but also be localized (and/or that a plurality or also an even number of errors can be detected). A localized error may be corrected by negation of the corresponding bit.

A Hamming code, etc., may, for instance, be used as error-correcting code.

Depending on the respectively used code and on the number of check bits, the number of detectable and/or correctable errors may be different.

By means of a SECDED code, two errors contained in the transmitted data bits may, for instance, be detected, and one error contained in the transmitted data bits may be corrected (SECDED=Single Error Correction, Dual Error Detection), etc.

If the error detection or correction control device 7 detects that an error has occurred during the storing and/or reading out of (reference) data, the error detection or correction control means 7 initiates—correspondingly identical as explained above with reference to the temperature measuring means 6 or step I illustrated in FIG. 2—that the voltage level at the above-mentioned further line 4d is drawn from “logic high” to “logic low”—or at the first line of the further line pair 4d from “logic high” to “logic low” and at the second line of the further line pair 4d from “logic low” to “logic high”.

In other words, the error detection or correction control means 7 sends, via the further line 4d or the further line pair 4d, respectively, the above-mentioned status signal RESET/TEMP_OVERHEAT/ECC_ERR/POWERDOWNEXIT to the memory device control means 5. Shortly afterwards, the further line 4d is again drawn back from “logic low” to “logic high” by the error detection or correction control means 7 (or the first line of the further line pair 4d back from “logic low” to “logic high” and the second line of the further line pair 4d back from “logic high” to “logic low”). Alternatively, the error detection or correction control means 7 may first wait for a signal sent by the control means 5 and acknowledging the receipt of the status signal RESET/TEMP_OVERHEAT/ECC_ERR/POWERDOWNEXIT.

Furthermore, the error detection or correction control means 7 writes data concerning the error detected, or other data (e.g., a bit indicating that an error has occurred, and/or the address assigned to the data detected as faulty or the address region assigned to the data detected as faulty, the respectively detected check bits or the respectively detected checksum, a code characterizing the data of a faulty data transmission, etc.) into the above-mentioned additional register 7a provided on the semiconductor memory device 1.

Subsequently, the data stored in the register 6a and the data stored in the additional register 7a are (e.g., simultaneously, or successively) read out and (e.g., simultaneously, or successively) transmitted via the above-mentioned reference data bus 4a of the bus system 4—which is otherwise provided for the transmission of reference data—from the semiconductor memory device 1 to the memory device control means 5 or the memory controller 5 (corresponding to step II illustrated in FIG. 2). Alternatively, only the data stored in the register 7a are read out and transmitted to the memory device control means 5 or the memory controller 5.

In the above-mentioned alternative embodiment of the invention illustrated in FIG. 3, the data stored in the register 6a and the data stored in the additional register 7a are, instead via the reference data bus 4a of the bus system 4, transmitted from the semiconductor memory device 1 to the memory device control means 5 or memory controller 5 via the above-mentioned separate, additional bus system 4e (again e.g., simultaneously (or successively)).

In the above-mentioned further, alternative variant, the transmission of the data stored in the registers 6a, 7a may be performed from the semiconductor memory device 1 to the memory device control means 5 or the memory controller 5, as has been mentioned, also—instead via an additional bus system 4e or the reference data bus 4a of the bus system 4—via the above-mentioned further line 4d or the above-mentioned further line pair 4d.

Depending on the data contained in the register 6a and in the additional register 7a, the control means 5 or the memory controller may take the respectively suited measures, e.g., correspondingly delay the further reading or writing of data from the semiconductor memory device 1 or into the semiconductor memory device 1, or reduce the data rate correspondingly (so that the semiconductor memory device 1 may cool down again), and/or repeat one or several read or write processes again, or reset the semiconductor memory device 1 to a predefined initial state, etc.

If the semiconductor memory device 1 is to be reset to the predefined initial state, or if the semiconductor memory device 1 is to change from a current saving mode or a sleep mode, respectively, back to a regular operation mode, or if any other change of mode is to take place, etc., etc., the control means 5 or the memory controller initiates—correspondingly similar as explained above with reference to the temperature measuring means 6 or the error detection control means 7 provided on the semiconductor device 1, or step 1 illustrated in FIG. 2, respectively—that the voltage level at the above-mentioned further line 4d is drawn from “logic high” to “logic low”- or with the first line of the further line pair 4d from “logic high” to “logic low”, and with the second line of the further line pair 4d from “logic low” to “logic high”.

In other words, in the above-mentioned cases the above-mentioned status signal RESET/TEMP_OVERHEAT/ECC_ERR/POWERDOWNEXIT is also sent via the further line 4d or the further line pair 4d, respectively (in these cases, however, not from the semiconductor memory device 1 to the control means 5, but—in reverse direction—from the control means 5 to the semiconductor memory device 1). Shortly after that, the further line 4d is drawn back again from “logic low” to “logic high” by the control means 5 (or the first line of the further line pair 4d back from “logic low” to “logic high”, and the second line of the further line pair 4d back from “logic high” to “logic low”).

Subsequently, data that specify the status signal RESET/TEMP_OVERHEAT/ECC_ERR/POWERDOWNEXIT in more detail may, via the above-mentioned reference data bus 4a of the bus system 4—which is otherwise provided for the transmission of reference data—, be transmitted from the memory device control means 5 or the memory controller 5 to the semiconductor memory device 1 (corresponding to step II illustrated in FIG. 2).

Alternatively, the data that specify the status signal RESET/TEMP_OVERHEAT/ECC_ERR/POWERDOWNEXIT in more detail may, correspondingly as illustrated in FIG. 3, be transmitted from the memory device control means 5 or the memory controller 5 to the semiconductor memory device 1 via the above-mentioned separate, additional bus system 4e instead via the reference data bus 4a of the bus system 4.

In a further, alternative variant, the transmission of the data that specify the status signal RESET/TEMP_OVERHEAT/ECC_ERR/POWERDOWNEXIT in more detail may be performed from the memory device control means 5 or the memory controller 5 to the semiconductor memory device 1 also via the above-mentioned further line 4d or the above-mentioned further line pair 4d-instead via an additional bus system 4e or the reference data bus 4a of the bus system 4.

By the data that specify the status signal RESET/TEMP_OVERHEAT/ECC_ERR/POWERDOWNEXIT in more detail—e.g., a corresponding first code or a second code different therefrom—it may be determined whether the semiconductor memory device 1 is to return to the above-mentioned predefined initial state, e.g., in reaction to the receipt of the data (correspondingly similar as conventional semiconductor memory devices after the receipt of a conventional reset signal), or whether the semiconductor memory device 1 is to change back from the above-mentioned current saving mode or sleep mode to the regular operating mode (correspondingly similar as conventional semiconductor memory devices after the receipt of a conventional waking or “PowerDownExit” signal), etc., etc.

In the current saving mode or sleep mode, the semiconductor memory device 1 will merely monitor the state of the further line 4d or of the further line pair 4d, not, however, the state of the remaining lines of the bus system 4 (or of the bus system 4e, respectively). Thus, it is possible to strongly reduce current consumption in the sleep mode.

In an alternative embodiment of the invention, the sending of the data specifying the status signal RESET/TEMP_OVERHEAT/ECC_ERR/POWERDOWNEXIT in more detail may be renounced. The semiconductor memory device 1 will then change after receipt of the status signal RESET/TEMP_OVERHEAT/ECC_ERR/POWERDOWNEXIT—directly and automatically—from the respective mode to a respective subsequent mode that has already been predefined for the respective mode (e.g., automatically from the current saving mode or sleep mode to the regular operating mode, from the regular operating mode to the reset mode, etc.).

If, as explained above, the control means 5 or the memory controller 5 sends, via the further line 4d or the further line pair 4d, a status signal RESET/TEMP_OVERHEAT/ECC_ERR/POWERDOWNEXIT (corresponding to step I illustrated in FIG. 2), i.e. initiates that the voltage level at the above-mentioned further line 4d (or the further line pair 4d) is drawn from “logic high” to “logic low”, the control means 5 or the memory controller 5 may—additionally—monitor whether a corresponding status signal RESET/TEMP_OVERHEAT/ECC_ERR/POWERDOWNEXIT is simultaneously or competitively also sent from the semiconductor memory device 1 via the further line 4d or the further line pair 4d (in that the semiconductor memory device 1 (or, as explained above, the means 6 or 7) also draws the further line 4d from “logic high” to “logic low”).

In this case, the voltage level at the above-mentioned further line 4d decreases even further—below a predefined threshold value—as if merely the control means 5, not, however, the semiconductor memory device 1 draws the further line 4d from “logic high” to “logic low”. If the control means 5 detects that the voltage level at the above-mentioned further line 4d decreases below the above-mentioned predefined threshold value (i.e. the control means 5 and the semiconductor memory device 1 competitively send a status signal RESET/TEMP_OVERHEAT/ECC_ERR/POWERDOWNEXIT), the control means 5 cancels the respective operation, or the control means 5 does not send any data specifying the status signal RESET/TEMP_OVERHEAT/ECC_ERR/POWERDOWNEXIT in more detail to the semiconductor memory device 1, respectively.

Instead—correspondingly as explained above—the data stored in the registers 6a, 7a that are provided on the semiconductor memory device 1 are sent to the control means 5 and are evaluated. To reduce the difficulties involved with the above-described competitive sending of a status signal RESET/TEMP_OVERHEAT/ECC_ERR/POWERDOWNEXIT by the control means 5 and the semiconductor memory device 1, in a further, alternative, not illustrated embodiment, two respective unidirectional further lines or two unidirectional further line pairs may be used instead of one single—bidirectional—further line 4d or one single—bidirectional—further line pair 4d. A first line or a first line pair of the two further lines or line pairs may then serve, correspondingly as described above, to send a respective signal corresponding to the above-mentioned status signal RESET/TEMP_OVERHEAT/ECC_ERR/POWERDOWNEXIT from the semiconductor memory device 1 to the control means 5. A second line or a second line pair of the two further lines or line pairs may be used to transmit—in reverse direction—a signal corresponding to the above-mentioned status signal RESET/TEMP_OVERHEAT/ECC_ERR/POWERDOWNEXIT from the control means 5 to the semiconductor memory device 1.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A semiconductor memory device system comprising:
a memory device; and
a controller connected with the memory device via a bus system; and
wherein a single signal line or a single signal line pair of the bus system is provided for transmitting a status signal that signalizes that control data are to be transmitted from the memory device to the controller, or from the controller to the memory device, the status signal comprising at least one of a resent signal, a temperature overheat signal, and ECC error signal, or a power down exit signal.

2. The semiconductor memory device system according to claim 1, wherein the bus system comprises:
a reference data bus;
an address bus; and
a control bus, and wherein the signal line or the signal line pair is part of the control bus, and wherein the control data are transmitted via the reference data bus—which is otherwise provided for the transmission of reference data—, and/or via the address bus—which is otherwise provided for the transmission of address data.

3. The semiconductor memory device system according to claim 1, wherein the bus system comprises:
a reference data bus, an address bus; and
a control bus; and
wherein the signal line or the signal line pair is part of the control bus, and wherein the control data are transmitted via a separate bus system that is provided in addition to the bus system.

4. The semiconductor memory device system according to claim 1, wherein the status signal configured to be sent bidirectionally, both from the memory device to the controller and from the controller to the memory device.

5. The semiconductor memory device according to claim 1, wherein, for the transmission of the status signal, the voltage level of the signal line or of the signal line pair is changed.

6. The semiconductor memory device system according to claim 1, wherein the control data are data generated by a temperature measuring means provided on the memory device.

7. The semiconductor memory device system according to claim 1, wherein the control data are data generated by an error detection/error correction control means provided on the memory device

8. The semiconductor memory device system according to claim 1, wherein the control data are reset command data sent to the memory device.

9. The semiconductor memory device system according to claim 1, wherein the control data are mode change command data sent to the memory device.

10. The semiconductor memory device system according to claim 4, wherein the memory device and/or the control means comprise(s) means for detecting whether—competitively—a status signal has simultaneously been sent both from the memory device and from the control means via the single signal line or the single signal line pair.

11. A semiconductor memory device system comprising:
a memory device; and
a control means connected with the memory device via a bus system; and
wherein a single signal line or a single signal line pair of the bus system is provided for transmitting a status signal that signalizes that control data are to be transmitted from the memory device to the control means, or from the control means to the memory device, the status signal comprising at least one of a reset signal, a temperature overheat signal, and ECC error signal, or a power down exit signal, and wherein, for the transmission of the status signal, the voltage level of the signal line or of the signal line pair is changed.

12. The semiconductor memory device system according to claim 11, wherein the bus system comprises:
a reference data bus;
an address bus; and
a control bus, and wherein the signal line or the signal line pair is part of the control bus, and wherein the control data are transmitted via the reference data bus—which is otherwise provided for the transmission of reference data—, and/or via the address bus—which is otherwise provided for the transmission of address data.

13. The semiconductor memory device system according to claim 11, wherein the status signal is adapted to be sent—bidirectionally—both from the memory device to the control means and from the control means to the memory device.

14. The semiconductor memory device system according to claim 13, wherein the control data are data generated by a temperature measuring means provided on the memory device.

15. The semiconductor memory device system according to claim 13, wherein the control data are data generated by an error detection/error correction control means provided on the memory device

16. The semiconductor memory device system according to claim 13, wherein the control data are reset command data sent to the memory device.

17. The semiconductor memory device system according to claim 13, wherein the control data are mode change command data sent to the memory device.

18. The semiconductor memory device system according to claim 13, wherein the memory device and/or the control means comprise(s) means for detecting whether—competitively—a status signal has simultaneously been sent both from the memory device and from the control means via the single signal line or the single signal line pair.

19. A semiconductor memory device system comprising:
a memory device; and
means for controlling connected with the memory device via a bus system; and wherein a single signal line or a single signal line pair of the bus system is provided for transmitting a status signal that signalizes that control data are to be transmitted from the memory device to the control means, or from the control means to the memory device, the status signal comprising at least one of a resent signal, a temperature overheat signal, and ECC error signal, or a power down exit signal.

20. A method for operating a semiconductor memory device system comprising:
providing a memory device and a control means connected with the memory device via a bus system;
transmitting a status signal comprising at least one of a resent signal, a temperature overheat signal, and ECC error signal, or a power down exit signal via a single signal line or a single signal line pair of the bus system, the status signal signalizing that control data are to be transmitted from the memory device to the control means, or from the control means to the memory device.
